(19) United States
(12) Patent Application Publication
(10) Pub. No.: US 2026/0155925 A1
(43) Pub. Date: Jun. 4, 2026

(54) SOUNDING REFERENCE SIGNAL RESOURCES WITH UNEQUAL PERIODICITIES

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/707,408

(22) PCT Filed: Jan. 11, 2022
(86) PCT No.: PCT/CN2022/071278

§ 371 Date: May 3, 2024

(51) Int. Cl. H04L 5/00; H04W 72/04

(52) U.S. Cl. CPC H04L 5/0048; H04W 72/04

(57) ABSTRACT

Various aspects of the present disclosure generally relate to wireless communication. In some aspects, a user equipment (UE) may configure a first subset of sounding reference signal (SRS) resources of an SRS resource set with a first periodicity where each SRS resource includes a first set of SRS antenna ports of the UE and configure a second subset of SRS resources of the SRS resource set with a second periodicity where each SRS resource includes a second set of SRS antenna ports of the UE. The UE may transmit the first subset of SRS resources according to the first periodicity and the second subset of SRS resources according to the second periodicity. Numerous other aspects are described.

### FIELD OF THE DISCLOSURE

Aspects of the present disclosure generally relate to wireless communication and to techniques and apparatuses for sounding reference signal resources with unequal periodicities.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include configuring a first subset of sounding reference signal (SRS) resources of an SRS resource set with a first periodicity where each SRS resource includes a first set of SRS antenna ports of the UE and configuring a second subset of SRS resources of the SRS resource set with a second periodicity where each SRS resource includes a second set of SRS antenna ports of the UE. The method may include transmitting the first subset of SRS resources according to the first periodicity and the second subset of SRS resources according to the second periodicity.

Some aspects described herein relate to a method of wireless communication performed by a base station. The method may include transmitting, to a UE, an indication for the UE to use a first subset of SRS resources of an SRS resource set with a first periodicity where each SRS resource includes a first set of SRS antenna ports of the UE and a second subset of SRS resources of the SRS resource set with a second periodicity where each SRS resource includes a second set of SRS antenna ports of the UE. The method may include receiving the first subset of SRS resources according to the first periodicity and the second subset of SRS resources according to the second periodicity.

Some aspects described herein relate to a UE for wireless communication. The UE may include a memory and one or more processors coupled to the memory. The one or more processors may be configured to configure a first subset of SRS resources of an SRS resource set with a first periodicity where each SRS resource includes a first set of SRS antenna ports of the UE. The one or more processors may be configured to configure a second subset of SRS resources of the SRS resource set with a second periodicity where each SRS resource includes a second set of SRS antenna ports of the UE. The one or more processors may be configured to transmit the first subset of SRS resources according to the first periodicity and the second subset of SRS resources according to the second periodicity.

Some aspects described herein relate to a base station for wireless communication. The base station may include a memory and one or more processors coupled to the memory. The one or more processors may be configured to transmit, to a UE, an indication for the UE to use a first subset of SRS resources of an SRS resource set with a first periodicity where each SRS resource includes a first set of SRS antenna ports of the UE and a second subset of SRS resources of the SRS resource set with a second periodicity where each SRS resource includes a second set of SRS antenna ports of the UE. The one or more processors may be configured to receive the first subset of SRS resources according to the first periodicity and the second subset of SRS resources according to the second periodicity.

Some aspects described herein relate to a non-transitory computer-readable medium that stores a set of instructions for wireless communication by a UE. The set of instructions, when executed by one or more processors of the UE, may cause the UE to configure a first subset of SRS resources of an SRS resource set with a first periodicity where each SRS resource includes a first set of SRS antenna ports of the UE and configure a second subset of SRS resources of the SRS resource set with a second periodicity where each SRS resource includes a second set of SRS antenna ports of the UE. The set of instructions, when executed by one or more processors of the UE, may cause the UE to transmit the first subset of SRS resources according to the first periodicity and the second subset of SRS resources according to the second periodicity.

Some aspects described herein relate to a non-transitory computer-readable medium that stores a set of instructions for wireless communication by a base station. The set of instructions, when executed by one or more processors of the base station, may cause the base station to transmit, to a UE, an indication for the UE to use a first subset of SRS resources of an SRS resource set with a first periodicity where each SRS resource includes a first set of SRS antenna ports of the UE and a second subset of SRS resources of the SRS resource set with a second periodicity where each SRS resource includes a second set of SRS antenna ports of the UE. The set of instructions, when executed by one or more processors of the base station, may cause the base station to receive the first subset of SRS resources according to the first periodicity and the second subset of SRS resources according to the second periodicity.

Some aspects described herein relate to an apparatus for wireless communication. The apparatus may include means for configuring a first subset of SRS resources of an SRS resource set with a first periodicity where each SRS resource includes a first set of SRS antenna ports of the apparatus and means for configuring a second subset of SRS resources of the SRS resource set with a second periodicity where each SRS resource includes a second set of SRS antenna ports of the apparatus. The apparatus may include means for transmitting the first subset of SRS resources according to the first periodicity and the second subset of SRS resources according to the second periodicity.

Some aspects described herein relate to an apparatus for wireless communication. The apparatus may include means for transmitting, to a UE, an indication for the UE to use a first subset of SRS resources of an SRS resource set with a first periodicity where each SRS resource includes a first set of SRS antenna ports of the UE and a second subset of SRS resources of the SRS resource set with a second periodicity where each SRS resource includes a second set of SRS antenna ports of the UE. The apparatus may include means for receiving the first subset of SRS resources according to the first periodicity and the second subset of SRS resources according to the second periodicity.

Aspects generally include a method, apparatus, system, computer program product, non-transitory computer-readable medium, UE, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of antenna ports, in accordance with the present disclosure.

FIG. 4 is a diagram illustrating an example of physical channels and reference signals in a wireless network, in accordance with the present disclosure.

FIG. 5 is a diagram illustrating an example of sounding reference signal (SRS) resource sets, in accordance with the present disclosure.

FIG. 6 is a diagram illustrating an example of predictive beam management, in accordance with the present disclosure.

FIG. 7 is a diagram illustrating an example of indicating SRS resource subsets of unequal periodicities, in accordance with the present disclosure.

FIG. 8 is a diagram illustrating an example of indicating an SRS configuration, in accordance with the present disclosure.

FIG. 9 is a diagram illustrating an example process performed, for example, by a UE, in accordance with the present disclosure.

FIG. 10 is a diagram illustrating an example process performed, for example, by a base station, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

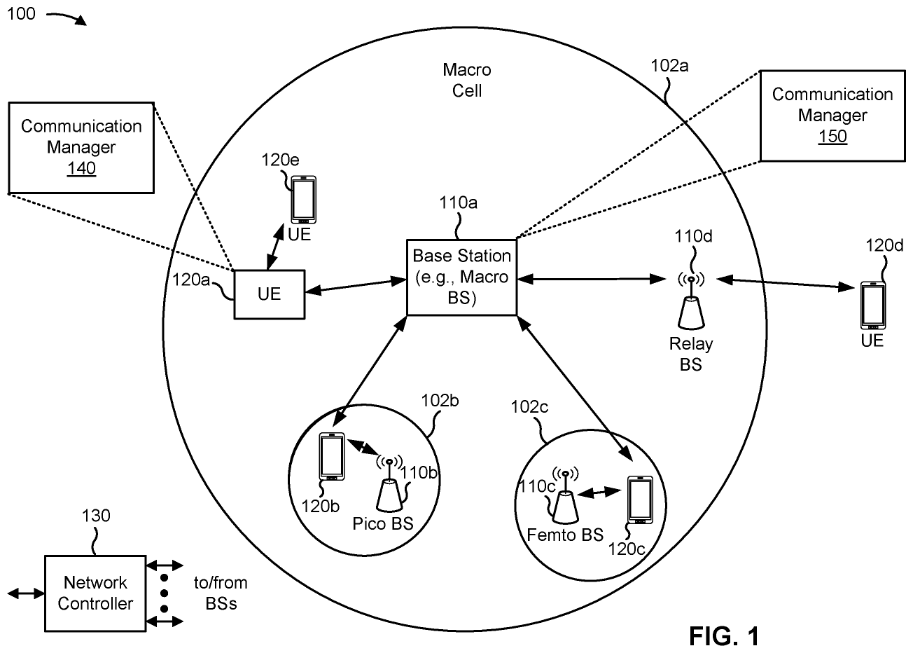

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR 1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may configure a first subset of sounding reference signal (SRS) resources of an SRS resource set with a first periodicity where each SRS resource includes a first set of SRS antenna ports of the UE and configure a second subset of SRS resources of the SRS resource set with a second periodicity where each SRS resource includes a second set of SRS antenna ports of the UE. The communication manager 140 may transmit the first subset of SRS resources according to the first periodicity and the second subset of SRS resources according to the second periodicity. Additionally, or alternatively, the communication manager 140 may perform one or more other operations described herein.

In some aspects, the base station 110 may include a communication manager 150. As described in more detail elsewhere herein, the communication manager 150 may transmit, to a UE, an indication for the UE to use a first subset of SRS resources of an SRS resource set with a first periodicity where each SRS resource includes a first set of SRS antenna ports of the UE and a second subset of SRS resources of the SRS resource set with a second periodicity where each SRS resource includes a second set of SRS antenna ports of the UE. The communication manager 150 may receive the first subset of SRS resources according to the first periodicity and the second subset of SRS resources according to the second periodicity. Additionally, or alternatively, the communication manager 150 may perform one or more other operations described herein.

As indicated above, FIG. 1 is provided as an example. Other examples may differ from what is described with regard to FIG. 1.

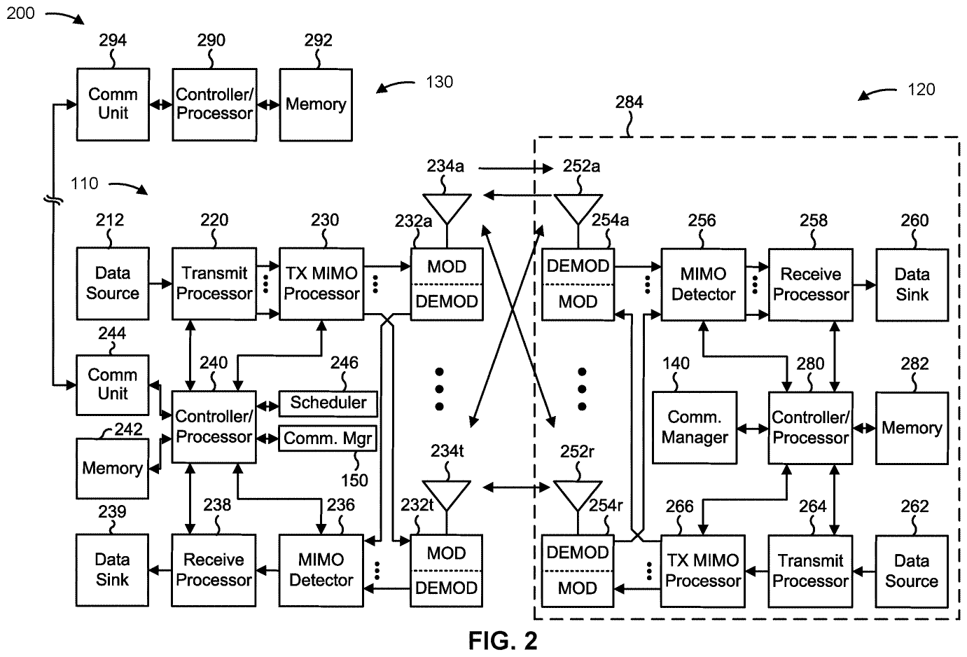

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or higher layer signaling) and provide overhead symbols and control symbols. Higher layer (upper layer) signaling may include signaling controlled at higher layers, such as the session layer, the presentation layer, or the application layer of the Open Systems Interconnection (OSI) model. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., Tmodems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

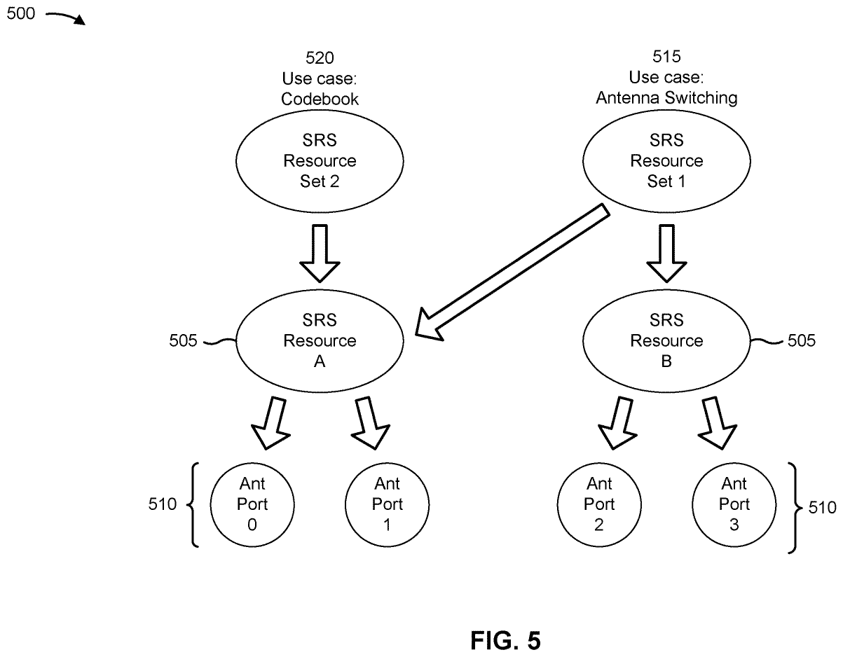

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-12).

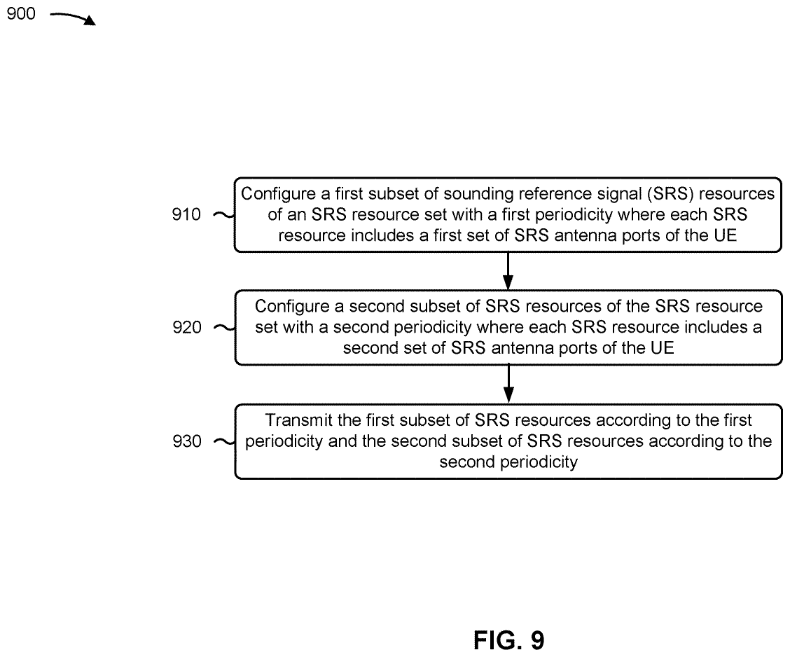

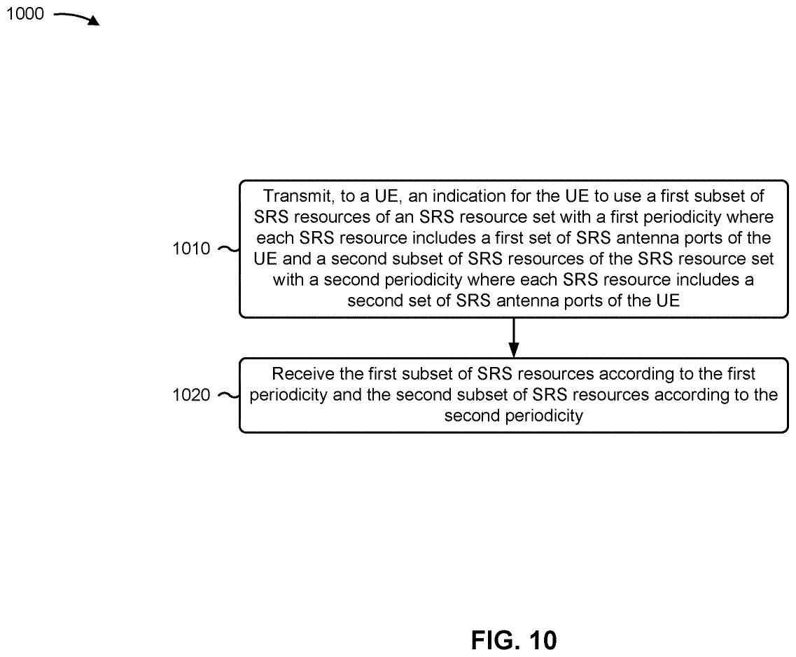

The controller/processor 240 of the base station 110, the controller/processor 280 of the UE 120, and/or any other component(s) of FIG. 2 may perform one or more techniques associated with SRS resources with unequal periodicities, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for configuring a first subset of SRS resources of an SRS resource set with a first periodicity where each SRS resource includes a first set of SRS antenna ports of the UE and means for configuring a second subset of SRS resources of the SRS resource set with a second periodicity where each SRS resource includes a second set of SRS antenna ports of the UE; and/or means for transmitting the first subset of SRS resources according to the first periodicity and the second subset of SRS resources according to the second periodicity. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE, an indication for the UE to use a first subset of SRS resources of an SRS resource set with a first periodicity where each SRS resource includes a first set of SRS antenna ports of the UE and a second subset of SRS resources of the SRS resource set with a second periodicity where each SRS resource includes a second set of SRS antenna ports of the UE; and/or means for receiving the first subset of SRS resources according to the first periodicity and the second subset of SRS resources according to the second periodicity. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

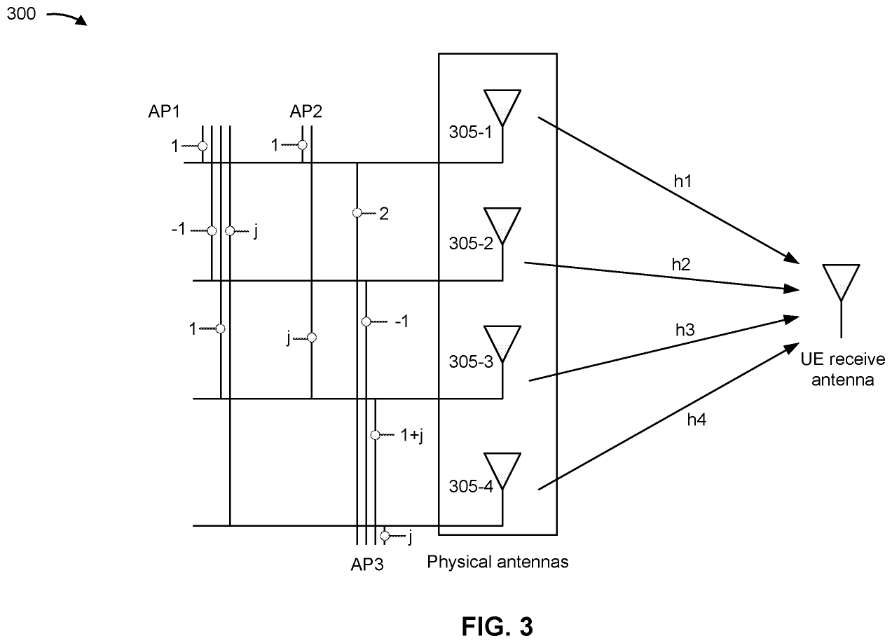

FIG. 3 is a diagram illustrating an example 300 of antenna ports, in accordance with the present disclosure.

As shown in FIG. 3, a first physical antenna 305-1 may transmit information via a first channel h1, a second physical antenna 305-2 may transmit information via a second channel h2, a third physical antenna 305-3 may transmit information via a third channel h3, and a fourth physical antenna 305-4 may transmit information via a fourth channel h4. Such information may be conveyed via a logical antenna port, which may represent some combination of the physical antennas and/or channels. In some cases, a UE 120 may not have knowledge of the channels associated with the physical antennas, and may only operate based on knowledge of the channels associated with antenna ports, as defined below.

An antenna port may be defined such that a channel, over which a symbol on the antenna port is conveyed, can be inferred from a channel over which another symbol on the same antenna port is conveyed. In example 300, a channel associated with antenna port 1 (AP1) is represented as h1−h2+h3+j*h4, where channel coefficients (e.g., 1, −1, 1, and j, in this case) represent weighting factors (e.g., indicating phase and/or gain) applied to each channel. Such weighting factors may be applied to the channels to improve signal power and/or signal quality at one or more receivers.

Applying such weighting factors to channel transmissions may be referred to as precoding, and “precoder” may refer to a specific set of weighting factors applied to a set of channels.

Similarly, a channel associated with antenna port 2 (AP2) is represented as h1+j*h3, and a channel associated with antenna port 3 (AP3) is represented as 2*h1−h2+(1+j)*h3+j*h4. In this case, antenna port 3 can be represented as the sum of antenna port 1 and antenna port 2 (e.g., AP3=AP1+AP2) because the sum of the expression representing antenna port 1 (h1−h2+h3+j*h4) and the expression representing antenna port 2 (h1+j*h3) equals the expression representing antenna port 3 (2*h1−h2+(1+j)*h3+j*h4). It can also be said that antenna port 3 is related to antenna ports 1 and 2 [AP1,AP2] via the precoder [1,1] because 1 times the expression representing antenna port 1 plus 1 times the expression representing antenna port 2 equals the expression representing antenna port 3.

In some aspects, the antenna ports may be used for transmitting SRS resources. Antenna ports that are used to transmit SRSs on SRS resources may also be referred to as “SRS-ports” or “SRS antenna ports.”

As indicated above, FIG. 3 is provided merely as an example. Other examples may differ from what is described with regard to FIG. 3.

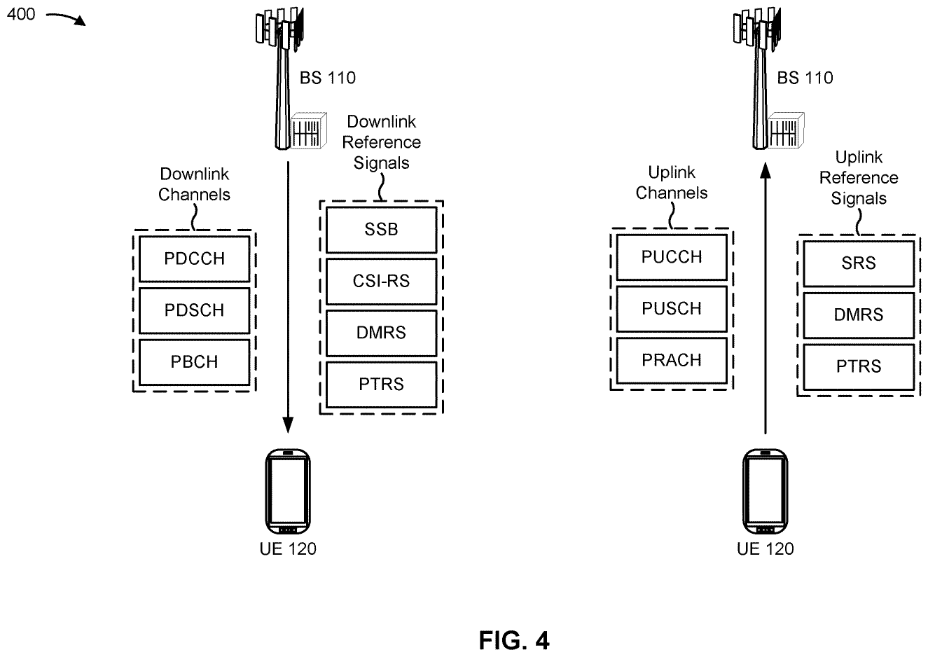

FIG. 4 is a diagram illustrating an example 400 of physical channels and reference signals in a wireless network, in accordance with the present disclosure. As shown in FIG. 4, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

A downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. An SSB may carry information used for initial network acquisition and synchronization, such as a primary synchronization signal (PSS), a secondary synchronization signa, a PBCH, and a PBCH DMRS. A CSI-RS may carry information used for downlink channel estimation (e.g., downlink CSI acquisition), which may be used for scheduling, link adaptation, or beam management, among other examples.

An uplink reference signal may include an SRS, a DMRS, or a PTRS, among other examples. A DMRS may carry information used to estimate a radio channel for demodulation of an associated physical channel (e.g., PDCCH, PDSCH, PBCH, PUCCH, or PUSCH). A PTRS may carry information used to compensate for oscillator phase noise. A PRS may carry information used to enable timing or ranging measurements of the UE 120 based on signals transmitted by the base station 110 to improve positioning that is based on observed time differences of arrival.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

FIG. 5 is a diagram illustrating an example 500 of SRS resource sets, in accordance with the present disclosure.

Base station 110 may configure UE 120 with one or more SRS resource sets to allocate resources for SRS transmissions by UE 120. For example, a configuration for SRS resource sets may be indicated in a radio resource control (RRC) message (e.g., an RRC configuration message or an RRC reconfiguration message). As shown by reference number 505, an SRS resource set may include one or more resources (e.g., shown as SRS resources), which may include time resources and/or frequency resources (e.g., a slot, a symbol, a resource block, and/or a periodicity for the time resources).

As shown by reference number 510, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case (e.g., in an SRS-SetUse information element) for the SRS resource set. For example, an SRS resource set may be used for antenna switching, codebook (CB) transmissions, non-CB transmissions, or beam management.

A CB SRS resource set may be used to indicate uplink CSI when base station 110 indicates an uplink precoder to UE 120. For example, when base station 110 is configured to indicate an uplink precoder to UE 120 (e.g., using a precoder CB), base station 110 may use a CB SRS (e.g., an SRS transmitted using a resource of a CB SRS resource set) to acquire uplink CSI (e.g., to determine an uplink precoder to be indicated to UE 120 and used by UE 120 to communicate with base station 110). In some aspects, virtual ports (e.g., a combination of two or more antenna ports) with a maximum transmit power may be supported at least for a CB SRS. Up to 4 SRS-ports may each be associated with an SRS resource of the CB SRS resource set. The 4 SRS-ports may be transmitted by the UE 120 through different physical antennas. All 4 of the SRS-ports may simultaneously transmit associated SRS resources. Antenna ports that correspond to the antennas may be indicated by a transmit precoding matrix index (TPMI), where the antenna ports of the TPMI are 1 -to-1 mapped to the transmitting SRS-ports. A 4×4 matrix indicated by the TPMI may indicate that the UE is to transmit a rank 4 transmission and a 4×2 matrix may indicted that the UE is to transmit a rank 2 transmission.

A non-CB SRS resource set may be used to indicate uplink CSI when UE 120 selects an uplink precoder (e.g., instead of base station 110 indicating an uplink precoder to be used by UE 120). For example, when UE 120 is configured to select an uplink precoder, base station 110 may use a non-CB SRS (e.g., an SRS transmitted using a resource of a non-CB SRS resource set) to acquire uplink CSI. In this case, the non-CB SRS may be precoded using a precoder selected by UE 120 (e.g., which may be indicated to base station 110).

An antenna switching SRS resource set may be used to indicate downlink CSI with reciprocity between an uplink and downlink channel. For example, when there is reciprocity between an uplink channel and a downlink channel, base station 110 may use an antenna switching SRS (e.g., an SRS transmitted using a resource of an antenna switching SRS resource set) to acquire downlink CSI (e.g., to determine a downlink precoder to be used to communicate with UE 120).

A beam management SRS resource set may be used for indicating CSI for millimeter wave communications.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a medium access control (MAC) control element (CE) (MAC CE)). An aperiodic SRS resource may be triggered dynamically, such as via DCI (e.g., UE-specific DCI or group common DCI) or a MAC CE.

In some aspects, UE 120 may be configured with a mapping between SRS ports (e.g., antenna ports) and corresponding SRS resources. UE 120 may transmit an SRS on a particular SRS resource using an SRS port indicated in the configuration. In some aspects, an SRS resource may span N adjacent symbols within a slot (e.g., where N equals 1, 2, or 4). UE 120 may be configured with X SRS ports (e.g., where X≤4).

In some aspects, each of the X SRS ports may mapped to a corresponding symbol of the SRS resource and used for transmission of an SRS in that symbol.

As shown in FIG. 5, in some aspects, different SRS resource sets indicated to UE 120 (e.g., having different use cases) may overlap (e.g., in time and/or in frequency, such as in the same slot). For example, as shown by reference number 515, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 520, a second SRS resource set (e.g., shown as SRS Resource Set 2) may be a CB use case. As shown, this example CB SRS resource set includes only the first SRS resource (shown as SRS Resource A). Thus, CB SRSs may be transmitted in SRS Resource A (e.g., the first time-frequency resource) using antenna port 0 and antenna port 1. In this case, UE 120 may not transmit CB SRSs in SRS Resource B (e.g., the second time-frequency resource) using antenna port 2 and antenna port 3.

As indicated above, FIG. 5 is provided as an example. Other examples may differ from what is described with regard to FIG. 5.

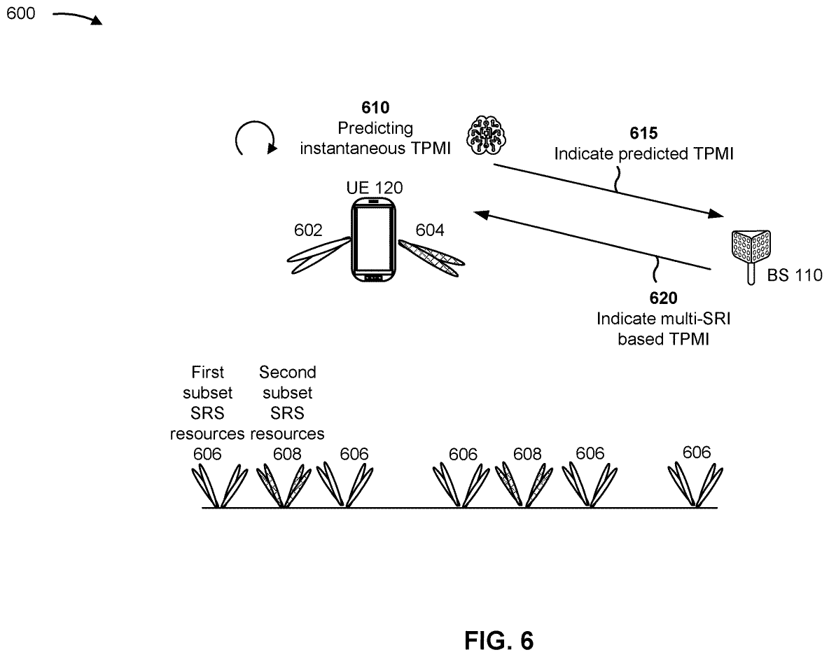

FIG. 6 is a diagram illustrating an example 600 of predictive beam management, in accordance with the present disclosure. Example 600 shows a UE (e.g., UE 120) that may communicate with a base station (e.g., base station 110).

A UE may be equipped with two antenna panels of antenna ports. The two antenna panels may be identical but, in some scenarios, the two antenna panels may be asymmetrical. For example, in a laptop, the first antenna panel may have fewer antennas than the second antenna panel. The first antenna panel may transmit with a smaller maximum transmit power than the second antenna panel. As shown in exampled 600, a UE (e.g., a UE 120) may be equipped with a first panel 602 that has a smaller maximum transmit power than a second panel 604. Having antenna panels of different sizes may provide the UE 120 more flexibility in functionality and power management.

In some aspects, the first panel 602 (with the smaller transmit power) may transmit more frequently than the second panel 604 (with the greater transmit power), to conserve battery power. That is, the first panel 602 may have a shorter period and a more frequent periodicity than the second panel 604. However, with respect to transmitting SRSs, current specifications (e.g., 3GPP technical specification (TS) 38.214 Section 6.2.1, TS 38.212 Section 7.3.1.1.2) specify use of a single period for an SRS resource set (and single SRI based TPMI) and do not support unequal or different periodicities for different antenna panels for the same SRS resource set and multiple SRS resource indicator (SRI) based TPMI.

According to various aspects described herein, the UE 120 may be configured with different antenna panels with unequal periodicities for the same SRS resource set. For example, the first panel 602 may transmit an SRS with a first subset of SRS resources 606 of an SRS resource set and transmit an SRS with a second subset of SRS resources 608 of the same SRS resource set. A subset of SRS resources may be a proper subset where less than all SRS resources of the SRS resource set are included in the subset of SRS resources. As shown in example 600, the first panel 602 may transmit more frequently than the second panel 604.

The base station 110 may transmit a TPMI whose antenna ports are jointly mapped to a first set of SRS antenna ports associated with a first SRS resource of the first subset of SRS resources 606 and a second set of SRS antenna ports associated with a second SRS resource of the second subset of SRS resources 608. The TPMI may be associated with multiple SRIs for SRS resources with unequal periodicities or associated with a single SRI for multiple SRS resources with unequal periodicities.

In some aspects, as shown by reference number 610, the UE 120 may use machine learning (e.g., artificial intelligence (AI)-based prediction) to predict a preferred (instantaneous) TPMI that jointly uses the two panels with unequal periodicities. The predicted TPMI may vary based on traffic and conditions for the two panels. The UE 120 may predict the TPMI while in a predictive uplink mode.

In some aspects, the UE 120 may use a machine learning model to predict the predicted TPMI (target variable) in connection with feedback associated with transmissions by the panels, including SRS transmissions, traffic conditions, or other information. The machine learning model may be trained using a machine learning system (e.g., neural network) at the UE 120, the base station 110, or associated with the UE 120. The machine learning model may be trained using a set of observations or other input, which may include training data (e.g., historical data related to different usage patterns of transmissions/receptions of multiple panels of a UE), feedback or measurements for transmissions from the multiple antenna panels (e.g., SRSs of the same SRS resource set or different SRS resource sets), and/or beam measurements associated with the antenna panels. In some aspects, the machine learning system may receive the set of observations or other input from the base station 110 or another device or network entity. The machine learning model may be a supervised learning model or an unsupervised learning model.

As shown by reference number 615, the UE 120 may transmit an indication of the predicted TPMI to the base station 110. The base station 110, when scheduling SRS resources for the UE 120 in the predictive uplink mode, as shown by reference number 620, may transmit a TPMI to have the UE 120 jointly use the two antenna panels with unequal periodicities. The TPMI may be the predicted TPMI or another TPMI selected by the base station 110. In some aspects, the base station 110 or another network entity may use machine learning to develop the predicted TPMI. By using unequal periodicities for antenna panels with different transmit powers for the same SRS resource set, the UE 120 may support predictive beam management for uplink beams and reduce power consumption when transmitting SRSs.

As indicated above, FIG. 6 is provided as an example. Other examples may differ from what is described with regard to FIG. 6.

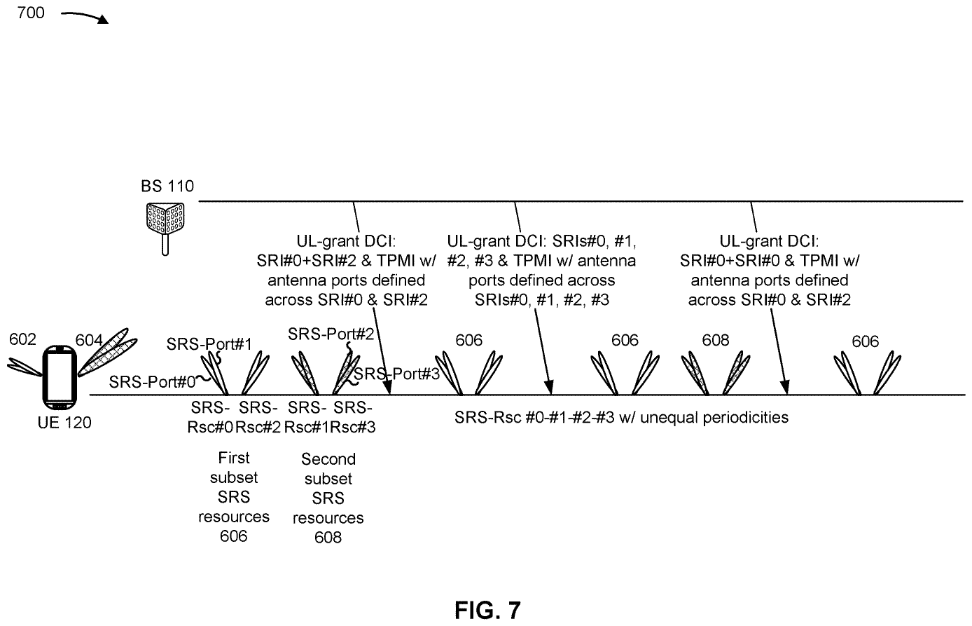

FIG. 7 is a diagram illustrating an example 700 of using SRS resources of unequal periodicities, in accordance with the present disclosure. The first subset of SRS resources 606 (with the first periodicity) and the second subset of SRS resources 608 (with the second periodicity) shown in example 600 may be part of the same SRS resource set, where a single SRS resource set includes unequal periodicities. Example 700 provides more details for the transmission of the subsets of SRS resources shown in example 600.

Each SRS resource may comprise 2 SRS-ports. The 2 SRS-ports may be in an X-pol configuration of 0 and +90 degrees. For example, the first subset of SRS resources 606 may comprise a first set of SRS ports, and the second subset of SRS resources 608 may comprise a second set of SRS ports. The base station 110 may transmit an uplink grant (UL-grant) downlink control information (DCI) or a radio resource control (RRC) configuration for configured grant for a physical uplink shared channel (CG-PUSCH) that indicates a first SRI associated with the first subset of SRS resources 606 and a second SRI associated with the second subset of SRS resources 608. The UL-grant DCI or RRC configuration for CG-PUSCH may also indicate a TPMI with antenna ports jointly associated with both the first subset of SRS resources 606 and the second subset of SRS resources 608, or both the first set of SRS ports and the second set of SRS ports. Alternatively, the UL-grant DCI or RRC configuration for CG-PUSCH may indicate a single SRI associated with both the first subset of SRS resources 606 and the second subset of SRS resources 608.

In example 700, the UE 120 may configure the first subset of SRS resources 606 with a first periodicity where each SRS resource includes a first set of SRS antenna ports of the UE 120 and configure the second subset of SRS resources 608 with a second periodicity where each SRS resource includes a second set of SRS antenna ports of the UE 120. The UE 120 may configure the first subset of SRS resources 606 with the first periodicity and the second subset of SRS resources 608 with the second periodicity jointly (in consideration of each other) or separately (independent of each other). The UE 120 may transmit the first subset of SRS resources 606 according to the first periodicity and the second subset of SRS resources 608 according to the second periodicity. The first periodicity may be, for example, 5 ms. The second periodicity may be, for example, 10 ms.

Example 700 shows multiple transmission occasions for transmitting SRSs on SRS resources from the first panel 602 (smaller transit power) and the second panel 604 (greater transmit power). In the first occasion, a UE 120 may transmit SRS resources using two SRS-ports (SRS-Port #0, SRS-Port #1) of the first panel 602 and two other SRS-ports (SRS-Port #2, and SRS-Port #3) of the second panel 604. More specifically, the first panel 602 may transmit SRS resource #0 (SRS-Rsc #0) and SRS resource #2 (SRS-Rsc #2) on SRS-port #0 and SRS-port #1. The SRS-ports may transmit in a time sequence using time division multiplexing (TDM). The second panel 604 may transmit SRS resource #1 (SRS-Rsc #1) and SRS resource #3 (SRS-Rsc #3) on SRS-port #2 and SRS-port #3. SRS-Rsc #0 and SRS-Rsc #2 (first subset of SRS resources 606) may have a different periodicity than SRS-Rsc #1 and SRS-Rsc #3 (second subset of SRS resources 608).

Example 700 shows that the base station 110 may indicate the SRS resources for the SRS-ports of the UE 120. The base station 110 may transmit UL-grant DCI with one or more SRIs and TPMIs with antenna ports defined across SRIs. The SRI or SRIs may indicate which SRS resources for the subsets of SRS resources that the UE 120 is to transmit. If a TPMI has a 4×4 matrix, rows #0/#1/#2/#3 in the TPMI matrix are associated with SRS-Ports #0/#1/#2/#3. To handle unequal periodicities, the TPMI may be associated with 2 SRS resources or 2 subsets of SRS resources. Previously, there was support for the TPMI supporting only one SRS resource with one periodicity. DMRS-ports #0/#1/#2/#3 may be associated with the respective rows #0/ #1/ #2/ #3 and the respective SRS-Ports #0/#1/#2/#3. The base station 110 may also transmit an RRC configuration message for CG-PUSCH that indicates the SRIs and/or the TPMI.

For example, as shown in example 700 for the second occasion, the UE 120 may receive an UL-grant DCI indicating SRI #0 for SRS-Rsc #0 and SRI #2 for SRS-Rsc #2. The UL-grant DCI may also include a TPMI with antenna ports defined across SRI #0 and SRI #2. The UE 120 may transmit the first subset of SRS resources 606, where SRS-Rsc #0 is transmitted on SRS-Port #0 and SRS-Port #1 and SRS-Rsc #2 is transmitted on SRS-Port #0 and SRS-Port #1. The transmissions may be code division multiplexed (CDMed), and the SRS resources may be time division multiplexed (TDMed). A transmission may be multiplexed based at least in part on the TPMI and a previous transmission (including port associations).

For the third occasion, the UE 120 may receive an UL-grant DCI indicating SRI #0 for SRS-Rsc #0, SRI #1 for SRS-Rsc #1, SRI #2 for SRS-Rsc #2, and SRS #3 for SRS-Rsc #3. The UE 120 may receive a joint SRI that indicates multiple SRS resources, such as SRS-Rsc #1 and SRS-Rsc #3. The UL-grant DCI may also include a TPMI with antenna ports defined across SRI #0, SRI #1, SRI #2, and SRI #3. That is, the TPMI may have antenna ports that are jointly associated with the first set of SRS-Ports and the second set of SRS-Ports. The UE 120 may transmit the first subset of SRS resources 606, where SRS-Rsc #0 is transmitted on SRS-Port #0 and SRS-Port #1 and SRS-Rsc #2 is transmitted on SRS-Port #0 and SRS-Port #1. The UE 120 may transmit the second subset of SRS resources 608, where SRS-Rsc #1 is transmitted on SRS-Port #2 and SRS-Port #3 and SRS-Rsc #3 is transmitted on SRS-Port #2 and SRS-Port #3. The transmissions may be CDMed. In sum, the UE 120 may transmit the first subset of SRS resources 606 from the first panel 602 with a smaller maximum transmit power and the second subset of SRS resources 608 from the second panel 604 with a greater maximum transmit power.

For the fourth occasion, the UE 120 may receive an UL-grant DCI indicating SRI #0 and SRS #2. The UL-grant DCI may also include a TPMI with antenna ports defined across SRI #0 and SRI #2. The UE 120 may transmit the first subset of SRS resources 606.

Alternatively, in some aspects, SRI #0 may be associated with the first subset of SRS resources 606 (rather than a single SRS resource) and the SRI #1 may be associated with the second subset of SRS resources 608.

As indicated above, FIG. 7 is provided as an example. Other examples may differ from what is described with regard to FIG. 7.

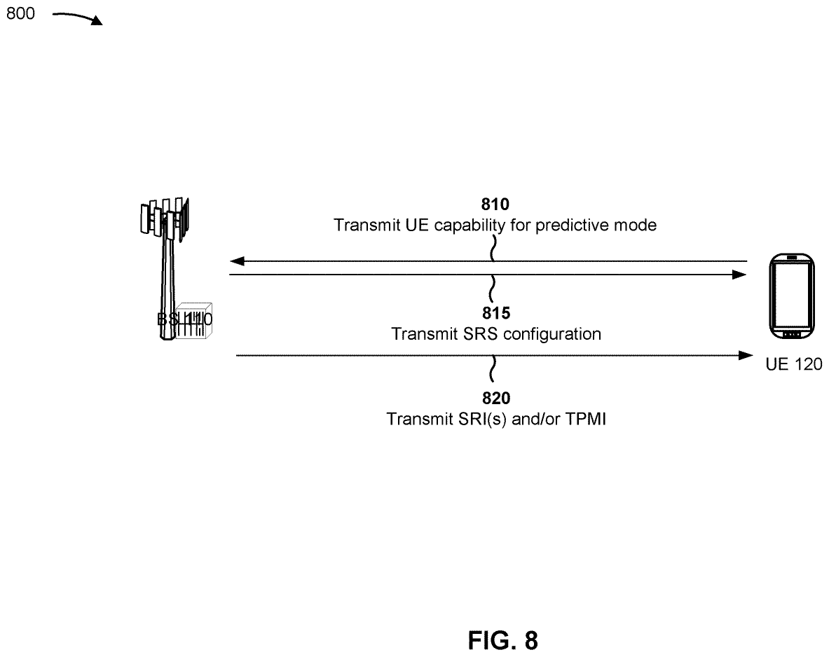

FIG. 8 is a diagram illustrating an example 800 of indicating an SRS configuration, in accordance with the present disclosure. FIG. 8 shows how the base station 110 may configure the UE 120 for SRS transmissions.

In some aspects, the UE 120 may be configured to expect that SRS resources within an SRS resource set (e.g., a legacy SRS resource set) may include different periodicities. The periodicities may be different at the slot level. The expectation may be based at least in part on whether a value for a higher layer parameter (e.g., usage-Predictive) associated with the SRS resource set is activated or deactivated. The UE 120 may have reported a UE capability for using the higher layer parameter in a particular uplink mode (e.g., a predictive mode), as shown by reference number 810.

The UE capability may also be for other aspects described herein. As shown by reference number 815, the base station 110 may transmit the SRS configuration for using the SRS resource set that includes SRS resources with different periodicities.

Alternatively, in some aspects, the UE 120 may be configured with a new type of SRS resource set (e.g., SRS-PredictiveResourceSet), where SRS resources within the SRS resource set include unequal periodicities.

In some aspects, the UE 120 may be configured for SRI and TPMI indication enhancement. An SRS-port index within the first subset of SRS resources and an SRS-port index within the second subset of SRS resources may be different. For example, as shown in FIG. 7, SRS-ports #0 and #1 may be used for SRS-Rsc #0 and SRS-Rsc #2, and SRS-ports #2 and #3 may be used for SRS-Rsc #1 and SRS-Rsc #3. As shown by reference number 820, the base station 110 may transmit one or more SRIs that correspond to the SRS resources of a single SRS resource set with unequal periodicities and/or an TPMI in an UL-grant DCI (or as configured for CG-PUSCH). The TPMI may include antenna ports that are mapped to the respective SRS-port indices. For example, the antenna ports #0/#1/#2/#3 indicated in the TPMI may be respectively associated with the SRS-ports #0/#1/#2/#3. The antenna ports of DMRS for PUSCH may follow the same associations defined for the antenna ports in the TPMI.

In some aspects, UL-grant DCI may be enhanced. For example, the SRI indicated in an UL-grant DCI may be associated with an SRS resource set configured by a higher layer parameter (e.g., srs-ResourceSetToAddModList) and associated with another higher layer parameter (e.g., usage-Predictive) that is activated. In another example, an SRS resource set that is configured for unequal periodicities (e.g., SRS-PredictiveResourceSet) may be associated with CB or non-CB usage, which may be configured by a higher layer parameter (e.g., srs-ResourceSetToAddModList-Predictive).

In some aspects, the CG-PUSCH enhancement may also be enhanced with SRIs and TPMIs that indicate SRS resources of the same SRS resource set that have unequal periodicities. The CG-PUSCH enhancement may be configured via SRS-ResourceIndicator or other RRC messages in association with the configuration of the CG-PUSCH.

In some aspects, the SRS configuration may configure the UE 120 to operate in an uplink mode, such as an uplink predictive mode, for PUSCH transmissions. The uplink predictive mode may be a mode that is associated with using an SRS resource set with SRS resources of unequal periodicities. The uplink predictive mode may be activated by a higher layer parameter (e.g., txConfig-Predictive in pusch-Config) with a value of “activated.” The base station 110 may activate the uplink predictive mode at the UE 120 via a MAC CE or DCI. The DCI may be a new format that is specified for the uplink predictive mode.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120) performs operations associated with using SRS resources of an SRS resource set that have unequal periodicities.

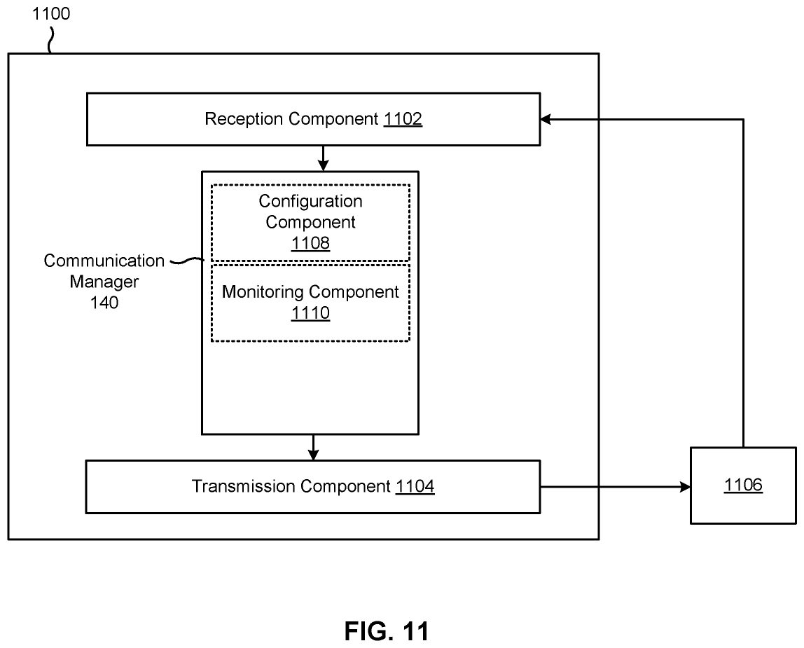

As shown in FIG. 9, in some aspects, process 900 may include configuring a first subset of SRS resources of an SRS resource set with a first periodicity where each SRS resource includes a first set of SRS antenna ports of the UE (block 910). For example, the UE (e.g., using communication manager 140 and/or configuration component 1108 depicted in FIG. 11) may configure a first subset of SRS resources of an SRS resource set with a first periodicity where each SRS resource includes a first set of SRS antenna ports of the UE, as described above.

As shown in FIG. 9, in some aspects, process 900 may include configuring a second subset of SRS resources of the SRS resource set with a second periodicity where each SRS resource includes a second set of SRS antenna ports of the UE (block 920). For example, the UE (e.g., using communication manager 140 and/or configuration component 1108 depicted in FIG. 11) may configure a second subset of SRS resources of the SRS resource set with a second periodicity where each SRS resource includes a second set of SRS antenna ports of the UE, as described above.

As further shown in FIG. 9, in some aspects, process 900 may include transmitting the first subset of SRS resources according to the first periodicity and the second subset of SRS resources according to the second periodicity (block 930). For example, the UE (e.g., using communication manager 140 and/or transmission component 1104 depicted in FIG. 11) may transmit the first subset of SRS resources according to the first periodicity and the second subset of SRS resources according to the second periodicity, as described above.

Process 900 may include additional aspects, such as any single aspect or any combination of aspects described below and/or in connection with one or more other processes described elsewhere herein.

In a first aspect, process 900 includes receiving an indication of a first SRS resource within the first subset of SRS resources and a second SRS resource within the second subset of SRS resources.

In a second aspect, alone or in combination with the first aspect, the indication includes a first SRI that indicates the first SRS resource and a second SRI that indicates the second SRS resource.

In a third aspect, alone or in combination with one or more of the first and second aspects, the indication includes an SRI that indicates both the first SRS resource and the second SRS resource.

In a fourth aspect, alone or in combination with one or more of the first through third aspects, receiving the indication includes receiving the indication in an UL-grant DCI or an RRC control message for CG-PUSCH.

In a fifth aspect, alone or in combination with one or more of the first through fourth aspects, the uplink grant DCI includes an SRI that is associated with the SRS resource set, and the configuring is based at least in part on being activated by a higher layer parameter that corresponds to using multiple periodicities in a single SRS resource set.

In a sixth aspect, alone or in combination with one or more of the first through fifth aspects, the configuring is based at least in part on activation of an uplink mode that corresponds to multiple periodicities in a single SRS resource set.

In a seventh aspect, alone or in combination with one or more of the first through sixth aspects, process 900 includes receiving a MAC CE or DCI that activates or deactivates the uplink mode.

In an eighth aspect, alone or in combination with one or more of the first through seventh aspects, process 900 includes monitoring for DCI that is dedicated to activating or deactivating the uplink mode.

In a ninth aspect, alone or in combination with one or more of the first through eighth aspects, the SRS resource set is associated with using CB values or non-CB values for multiple periodicities within a single SRS resource set.

In a tenth aspect, alone or in combination with one or more of the first through ninth aspects, the CG-PUSCH includes an SRI that is associated with the SRS resource set.

In an eleventh aspect, alone or in combination with one or more of the first through tenth aspects, receiving the indication includes receiving a TPMI whose antenna ports are jointly mapped to the first set of SRS antenna ports associated with the first SRS resource and the second set of SRS antenna ports associated with the second SRS resource.

In a twelfth aspect, alone or in combination with one or more of the first through eleventh aspects, a first type of the SRS resource set with the first periodicity and the second periodicity is different than a second type of an SRS resource set with a single periodicity for SRS resources.

In a thirteenth aspect, alone or in combination with one or more of the first through twelfth aspects, the UE is configured with an activated value and a deactivated value for a higher layer parameter that is associated with the SRS resource set having multiple periodicities.

In a fourteenth aspect, alone or in combination with one or more of the first through thirteenth aspects, process 900 includes transmitting an indication of a UE capability for using the SRS resource set with two periodicities or for using an activated value and a deactivated value for a higher layer parameter that is associated with the SRS resource set having multiple periodicities.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110) performs operations associated with using SRS resources with unequal periodicities.

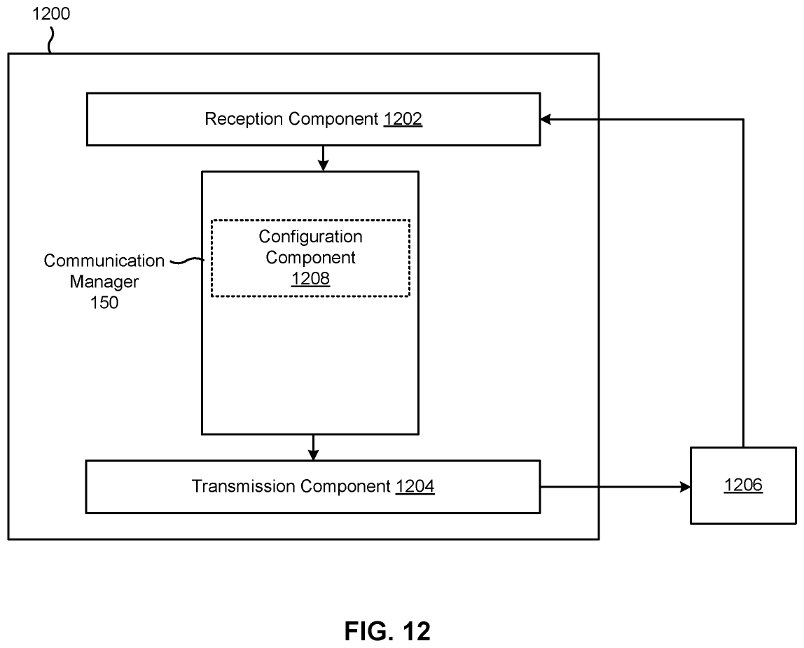

As shown in FIG. 10, in some aspects, process 1000 may include transmitting, to a UE, an indication for the UE to use a first subset of SRS resources of an SRS resource set with a first periodicity where each SRS resource includes a first set of SRS antenna ports of the UE and a second subset of SRS resources of the SRS resource set with a second periodicity where each SRS resource includes a second set of SRS antenna ports of the UE (block 1010). For example, the base station (e.g., using communication manager 150 and/or transmission component 1204 depicted in FIG. 12) may transmit, to a UE, an indication for the UE to use a first subset of SRS resources of an SRS resource set with a first periodicity where each SRS resource includes a first set of SRS antenna ports of the UE and a second subset of SRS resources of the SRS resource set with a second periodicity where each SRS resource includes a second set of SRS antenna ports of the UE, as described above.

As further shown in FIG. 10, in some aspects, process 1000 may include receiving the first subset of SRS resources according to the first periodicity and the second subset of SRS resources according to the second periodicity (block 1020). For example, the base station (e.g., using communication manager 150 and/or reception component 1202 depicted in FIG. 12) may receive the first subset of SRS resources according to the first periodicity and the second subset of SRS resources according to the second periodicity, as described above.

Process 1000 may include additional aspects, such as any single aspect or any combination of aspects described below and/or in connection with one or more other processes described elsewhere herein.

In a first aspect, the indication includes a first SRI that indicates the first SRS resource and a second SRI that indicates the second SRS resource.

In a second aspect, alone or in combination with the first aspect, the indication includes an SRI that indicates both the first SRS resource and the second SRS resource.

In a third aspect, alone or in combination with one or more of the first and second aspects, transmitting the indication includes transmitting the indication in an UL-grant DCI or an RRC message for CG-PUSCH.

In a fourth aspect, alone or in combination with one or more of the first through third aspects, the uplink grant DCI includes an SRI that is associated with the SRS resource set, and the indication activates a higher layer parameter that corresponds to using multiple periodicities in a single SRS resource set.

In a fifth aspect, alone or in combination with one or more of the first through fourth aspects, the indication activates an uplink mode that corresponds to using multiple periodicities in a single SRS resource set.

In a sixth aspect, alone or in combination with one or more of the first through fifth aspects, the SRS resource set is associated with using CB values or non-CB values for multiple periodicities within a single SRS resource set.

In a seventh aspect, alone or in combination with one or more of the first through sixth aspects, the CG-PUSCH includes an SRI that is associated with the SRS resource set.

In an eighth aspect, alone or in combination with one or more of the first through seventh aspects, transmitting the indication includes transmitting a TPMI whose antenna ports are jointly mapped to the first set of SRS antenna ports associated with the first SRS resource and the second set of SRS antenna ports associated with the second SRS resource.

In a ninth aspect, alone or in combination with one or more of the first through eighth aspects, process 1000 includes receiving an indication of a UE capability for using the RS resource set with two periodicities or for using an activated value and a deactivated value for a new higher layer parameter associated with the SRS resource set.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE (e.g., a UE 120), or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include a configuration component 1108 and/or a monitoring component 1110, among other examples.

In some aspects, the apparatus 1100 may be configured to perform one or more operations described herein in connection with FIGS. 1-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The configuration component 1108 may configure a first subset of SRS resources of an SRS resource set with a first periodicity where each SRS resource includes a first set of SRS antenna ports of the UE and configure a second subset of SRS resources of the SRS resource set with a second periodicity where each SRS resource includes a second set of SRS antenna ports of the UE. The transmission component 1104 may transmit the first subset of SRS resources according to the first periodicity and the second subset of SRS resources according to the second periodicity.

The reception component 1102 may receive an indication of a first SRS resource within the first subset of SRS resources and a second SRS resource within the second subset of SRS resources. The reception component 1102 may receive a MAC CE or DCI that activates or deactivates the uplink mode. The monitoring component 1110 may monitor for DCI that is dedicated to activating or deactivating the uplink mode.

The transmission component 1104 may transmit an indication of a UE capability for using the SRS resource set with two periodicities or for using an activated value and a deactivated value for a higher layer parameter that is associated with the SRS resource set having multiple periodicities.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a base station (e.g., a base station 110), or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a configuration component 1208, among other examples.

In some aspects, the apparatus 1200 may be configured to perform one or more operations described herein in connection with FIGS. 1-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the base station described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the base station described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station described in connection with FIG. 2. In some aspects, the transmission component 1204 may be co-located with the reception component 1202 in a transceiver.

The configuration component 1208 may configure the UE with an enhanced SRS configuration. The transmission component 1204 may transmit, to a UE, an indication for the UE to use a first subset of SRS resources of an SRS resource set with a first periodicity where each SRS resource includes a first set of SRS antenna ports of the UE and a second subset of SRS resources of the SRS resource set with a second periodicity where each SRS resource includes a second set of SRS antenna ports of the UE. The reception component 1202 may receive the first subset of SRS resources according to the first periodicity and the second subset of SRS resources according to the second periodicity.

The reception component 1202 may receive an indication of a UE capability for using the RS resource set with two periodicities or for using an activated value and a deactivated value for a new higher layer parameter associated with the SRS resource set.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: configuring a first subset of sounding reference signal (SRS) resources of an SRS resource set with a first periodicity where each SRS resource includes a first set of SRS antenna ports of the UE; configuring a second subset of SRS resources of the SRS resource set with a second periodicity where each SRS resource includes a second set of SRS antenna ports of the UE; and transmitting the first subset of SRS resources according to the first periodicity and the second subset of SRS resources according to the second periodicity.

Aspect 2: The method of Aspect 1, further comprising receiving an indication of a first SRS resource within the first subset of SRS resources and a second SRS resource within the second subset of SRS resources.

Aspect 3: The method of Aspect 2, wherein the indication includes a first SRS resource indicator (SRI) that indicates the first SRS resource and a second SRI that indicates the second SRS resource.

Aspect 4: The method of Aspect 2, wherein the indication includes an SRS resource indicator (SRI) that indicates both the first SRS resource and the second SRS resource.

Aspect 5: The method of any of Aspects 2-4, wherein receiving the indication includes receiving the indication in an uplink grant downlink control information (DCI) or a radio resource control message for configured grant on a physical uplink control channel (CG-PUSCH).

Aspect 6: The method of Aspect 5, wherein the uplink grant DCI includes an SRS resource indicator (SRI) that is associated with the SRS resource set, and wherein the configuring is based at least in part on being activated by a higher layer parameter that corresponds to using multiple periodicities in a single SRS resource set.

Aspect 7: The method of Aspect 5 or 6, wherein the configuring is based at least in part on activation of an uplink mode that corresponds to multiple periodicities in a single SRS resource set.

Aspect 8: The method of Aspect 7, further comprising receiving a medium access control control element (MAC CE) or DCI that activates or deactivates the uplink mode.

Aspect 9: The method of Aspect 7 or 8, further comprising monitoring for DCI that is dedicated to activating or deactivating the uplink mode.

Aspect 10: The method of any of Aspects 5-9, wherein the SRS resource set is associated with using codebook values or non-codebook values for multiple periodicities within a single SRS resource set.

Aspect 11: The method of any of Aspects 5-10, wherein the CG-PUSCH includes an SRS resource indicator (SRI) that is associated with the SRS resource set.

Aspect 12: The method of any of Aspects 2-11, wherein receiving the indication includes receiving a transmit precoding matrix index (TPMI) whose antenna ports are jointly mapped to the first set of SRS antenna ports associated with the first SRS resource and the second set of SRS antenna ports associated with the second SRS resource.

Aspect 13: The method of any of Aspects 1-12, wherein a first type of the SRS resource set with the first periodicity and the second periodicity is different than a second type of an SRS resource set with a single periodicity for SRS resources.

Aspect 14: The method of any of Aspects 1-13, wherein the UE is configured with an activated value and a deactivated value for a higher layer parameter that is associated with the SRS resource set having multiple periodicities.

Aspect 15: The method of any of Aspects 1-14, further comprising transmitting an indication of a UE capability for using the SRS resource set with two periodicities or for using an activated value and a deactivated value for a higher layer parameter that is associated with the SRS resource set having multiple periodicities.

Aspect 16: A method of wireless communication performed by a base station, comprising: transmitting, to a user equipment (UE), an indication for the UE to use a first subset of sounding reference signal (SRS) resources of an SRS resource set with a first periodicity where each SRS resource includes a first set of SRS antenna ports of the UE and a second subset of SRS resources of the SRS resource set with a second periodicity where each SRS resource includes a second set of SRS antenna ports of the UE; and receiving the first subset of SRS resources according to the first periodicity and the second subset of SRS resources according to the second periodicity.

Aspect 17: The method of Aspect 16, wherein the indication includes a first SRS resource indicator (SRI) that indicates the first SRS resource and a second SRI that indicates the second SRS resource.

Aspect 18: The method of Aspect 16, wherein the indication includes an SRS resource indicator (SRI) that indicates both the first SRS resource and the second SRS resource.

Aspect 19: The method of any of Aspects 16-18, wherein transmitting the indication includes transmitting the indication in an uplink grant downlink control information (DCI) or a radio resource control message for configured grant on a physical uplink control channel (CG-PUSCH).

Aspect 20: The method of Aspect 19, wherein the uplink grant DCI includes an SRS resource indicator (SRI) that is associated with the SRS resource set, and wherein the indication activates a higher layer parameter that corresponds to using multiple periodicities in a single SRS resource set.

Aspect 21: The method of Aspect 19 or 20, wherein the indication activates an uplink mode that corresponds to using multiple periodicities in a single SRS resource set.

Aspect 22: The method of any of Aspects 19-21, wherein the SRS resource set is associated with using codebook values or non-codebook values for multiple periodicities within a single SRS resource set.

Aspect 23: The method of any of Aspects 19-22, wherein the CG-PUSCH includes an SRS resource indicator (SRI) that is associated with the SRS resource set.

Aspect 24: The method of any of Aspects 16-23, wherein transmitting the indication includes transmitting a transmit precoding matrix index (TPMI) whose antenna ports are jointly mapped to the first set of SRS antenna ports associated with the first SRS resource and the second set of SRS antenna ports associated with the second SRS resource.

Aspect 25: The method of any of Aspects 16-24, further comprising receiving an indication of a UE capability for using the RS resource set with two periodicities or for using an activated value and a deactivated value for a new higher layer parameter associated with the SRS resource set.

Aspect 26: An apparatus for wireless communication at a device, comprising a processor; memory coupled with the processor; and instructions stored in the memory and executable by the processor to cause the apparatus to perform the method of one or more of Aspects 1-25.

Aspect 27: A device for wireless communication, comprising a memory and one or more processors coupled to the memory, the one or more processors configured to perform the method of one or more of Aspects 1-25.

Aspect 28: An apparatus for wireless communication, comprising at least one means for performing the method of one or more of Aspects 1-25.

Aspect 29: A non-transitory computer-readable medium storing code for wireless communication, the code comprising instructions executable by a processor to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
configure a first subset of sounding reference signal (SRS) resources of an SRS resource set with a first periodicity where each SRS resource includes a first set of SRS antenna ports of the UE;
configure a second subset of SRS resources of the SRS resource set with a second periodicity where each SRS resource includes a second set of SRS antenna ports of the UE; and
transmit the first subset of SRS resources according to the first periodicity and the second subset of SRS resources according to the second periodicity.

2. The UE of claim 1, wherein the one or more processors are configured to receive an indication of a first SRS resource within the first subset of SRS resources and a second SRS resource within the second subset of SRS resources.

3. The UE of claim 2, wherein the indication includes a first SRS resource indicator (SRI) that indicates the first SRS resource and a second SRI that indicates the second SRS resource.

4. The UE of claim 2, wherein the indication includes an SRS resource indicator (SRI) that indicates both the first SRS resource and the second SRS resource.

5. The UE of claim 2, wherein the one or more processors, to receive the indication, are configured to receive the indication in an uplink grant downlink control information (DCI) or a radio resource control message for configured grant on a physical uplink control channel (CG-PUSCH).

6. The UE of claim 5, wherein the uplink grant DCI includes an SRS resource indicator (SRI) that is associated with the SRS resource set, and wherein the configuring is based at least in part on being activated by a higher layer parameter that corresponds to using multiple periodicities in a single SRS resource set.

7. The UE of claim 5, wherein the configuring is based at least in part on activation of an uplink mode that corresponds to multiple periodicities in a single SRS resource set.

8. The UE of claim 7, wherein the one or more processors are configured to receive a medium access control control element (MAC CE) or DCI that activates or deactivates the uplink mode.

9. The UE of claim 7, wherein the one or more processors are further configured to monitor for DCI that is dedicated to activating or deactivating the uplink mode.

10. The UE of claim 5, wherein the SRS resource set is associated with using codebook values or non-codebook values for multiple periodicities within a single SRS resource set.

11. The UE of claim 5, wherein the CG-PUSCH includes an SRS resource indicator (SRI) that is associated with the SRS resource set.

12. The UE of claim 2, wherein the one or more processors, to receive the indication, are configured to receive a transmit precoding matrix index (TPMI) whose antenna ports are jointly mapped to the first set of SRS antenna ports associated with the first SRS resource and the second set of SRS antenna ports associated with the second SRS resource.

13. The UE of claim 1, wherein a first type of the SRS resource set with the first periodicity and the second periodicity is different than a second type of an SRS resource set with a single periodicity for SRS resources.

14. The UE of claim 1, wherein the UE is configured with an activated value and a deactivated value for a higher layer parameter that is associated with the SRS resource set having multiple periodicities.

15. The UE of claim 1, wherein the one or more processors are configured to transmit an indication of a UE capability for using the SRS resource set with two periodicities or for using an activated value and a deactivated value for a higher layer parameter that is associated with the SRS resource set having multiple periodicities.

16. A base station for wireless communication, comprising:
a memory; and
one or more processors, coupled to the memory, configured to:
transmit, to a user equipment (UE), an indication for the UE to use a first subset of sounding reference signal (SRS) resources of an SRS resource set with a first periodicity where each SRS resource includes a first set of SRS antenna ports of the UE and a second subset of SRS resources of the SRS resource set with a second periodicity where each SRS resource includes a second set of SRS antenna ports of the UE; and
receive the first subset of SRS resources according to the first periodicity and the second subset of SRS resources according to the second periodicity.

17. The base station of claim 16, wherein the indication includes a first SRS resource indicator (SRI) that indicates the first SRS resource and a second SRI that indicates the second SRS resource.

18. The base station of claim 16, wherein the indication includes an SRS resource indicator (SRI) that indicates both the first SRS resource and the second SRS resource.

19. The base station of claim 16, wherein the one or more processors, to transmit the indication, are configured to transmit the indication in an uplink grant downlink control information (DCI) or a radio resource control message for configured grant on a physical uplink control channel (CG-PUSCH).

20. The base station of claim 19, wherein the uplink grant DCI includes an SRS resource indicator (SRI) that is associated with the SRS resource set, and wherein the indication activates a higher layer parameter that corresponds to using multiple periodicities in a single SRS resource set.

21. The base station of claim 19, wherein the indication activates an uplink mode that corresponds to using multiple periodicities in a single SRS resource set.

22. The base station of claim 19, wherein the SRS resource set is associated with using codebook values or non-codebook values for multiple periodicities within a single SRS resource set.

23. The base station of claim 19, wherein the CG-PUSCH includes an SRS resource indicator (SRI) that is associated with the SRS resource set.

24. The base station of claim 16, wherein the one or more processors, to transmit the indication, are configured to transmit a transmit precoding matrix index (TPMI) whose antenna ports are jointly mapped to the first set of SRS antenna ports associated with the first SRS resource and the second set of SRS antenna ports associated with the second SRS resource.

25. The base station of claim 16, wherein the one or more processors are configured to receive an indication of a UE capability for using the RS resource set with two periodicities or for using an activated value and a deactivated value for a new higher layer parameter associated with the SRS resource set.

26. A method of wireless communication performed by a user equipment (UE), comprising:
configuring a first subset of sounding reference signal (SRS) resources of an SRS resource set with a first periodicity where each SRS resource includes a first set of SRS antenna ports of the UE;
configuring a second subset of SRS resources of the SRS resource set with a second periodicity where each SRS resource includes a second set of SRS antenna ports of the UE; and
transmitting the first subset of SRS resources according to the first periodicity and the second subset of SRS resources according to the second periodicity.

27. The method of claim 26, further comprising receiving an indication of a first SRS resource within the first subset of SRS resources and a second SRS resource within the second subset of SRS resources.

28. The method of claim 27, wherein receiving the indication includes receiving the indication in an uplink grant downlink control information (DCI) or a radio resource control message for configured grant on a physical uplink control channel (CG-PUSCH).

29. A method of wireless communication performed by a base station, comprising:
transmitting, to a user equipment (UE), an indication for the UE to use a first subset of sounding reference signal (SRS) resources of an SRS resource set with a first periodicity where each SRS resource includes a first set of SRS antenna ports of the UE and a second subset of SRS resources of the SRS resource set with a second periodicity where each SRS resource includes a second set of SRS antenna ports of the UE; and
receiving the first subset of SRS resources according to the first periodicity and the second subset of SRS resources according to the second periodicity.

30. The method of claim 29, wherein the indication activates an uplink mode that corresponds to using multiple periodicities in a single SRS resource set.
